(19) United States
(12) Patent Application Publication
(10) Pub. No.: US 2016/0244703 A1
(43) Pub. Date: Aug. 25, 2016

(54) BEVERAGE COMPOSITIONS AND METHOD OF MAKING BEVERAGES

(71) Applicant: Andrew R. Chadeayne, Bellevue, WA (US)

(72) Inventor: Andrew R. Chadeayne, Bellevue, WA (US)

(21) Appl. No.: 15/006,106

(22) Filed: Jan. 25, 2016

Related U.S. Application Data
(60) Provisional application No. 62/107,264, filed on Jan. 23, 2015.

(51) Int. Cl. C12C 5/00; C12C 7/04

(52) U.S. Cl. CPC C12C 5/002; C12C 5/00; C12C 7/04

(57) ABSTRACT

Disclosed herein are new methods of preparing foods and beverages under the exclusion of oxygen have now been invented. In one embodiment, one or more of the food processing steps are performed under an inert atmosphere.

### CROSS-REFERENCE TO RELATED APPLICATIONS

This application claims the benefit of U.S. Provisional Application No. 62/107,264, filed Jan. 23, 2015, the disclosure of which is incorporated herein by reference.

### TECHNICAL FIELD

This disclosure relates to the food and beverage arts. In one particular embodiment, this application relates to methods of making beer.

### BACKGROUND

Preparing food and beverages often involves heating the ingredients, i.e., cooking them. This process is virtually always preformed on the planet Earth. The planet Earth has an atmosphere comprising about 21% oxygen. Oxygen reacts with many of the ingredients used to prepare food and beverages. When oxygen reacts with these ingredients, it oxidizes them. Sometimes this oxidation is desirable. Many times this oxidation is not desirable. There exists a need to cook foods in an atmosphere substantially free from oxygen.

In the brewing arts, beer is made by first extracting sugar from malted barley, then boiling that extract in the presence of a flavonoid, such as hops, then cooling the mixture, then adding yeast, then allowing the yeast to convert the sugars into alcohol by fermentation.

Extracting sugars from malted barley is traditionally performed by triturating the malted barley with hot water in the presence of oxygen. Both the water and the ambient atmosphere include oxygen.

After extracting sugars into an aqueous solution, that solution is then further heated in the presence of ambient oxygen. Usually the sugar solution is heated for 60 to 120 minutes at a boiling temperature of about 100 degrees Celsius. During this boiling period, a flavonoid is often added to the boiling solution. Often this flavonoid comprises hops or other natural plant materials.

After heating or boiling the solution for period of time, the solution is cooled to a temperature suitable for yeast, usually below about 25 to 20 degrees Celsius.

Once the solution is cooled to a temperature suitable for yeast, yeast is added to the solution and allowed to ferment for a period of days. During this fermentation time, the yeast converts the sugars into alcohol.

Sometimes the fermenting solution comprising yeast is transferred one or more times to secondary fermentation vessels.

Sometimes additional flavonoids are added at one of more of the above-described post boil steps.

All of the above steps include exposing the ingredients to oxygen, which can react with those ingredients.

There exists a need to prepare foods (e.g., beer) in a manner that excludes oxygen at one or more of the processing steps. This need is especially important when the processing step is performed at a high temperature, such as a temperature above 50 degrees Celsius.

### DETAILED DESCRIPTION

New methods of preparing foods and beverages under the exclusion of oxygen have now been invented. In one embodiment, one or more of the food processing steps are performed under an inert atmosphere.

Disclosed herein is a method of making a beverage comprising:

adding water to a container;

sparging the water with inert gas;

filling the container with inert gas;

adding comestible material to the water; and

heating the water.

As used herein, the term “beverage” means a liquid composition that is suitable ingestion by humans. Within the context of this disclosure exemplary beverages include beer, coffee, tea, fruit juices, supplement drinks, energy drinks, and sports drinks. In one particular embodiment, the beverage is beer, which requires unique processing conditions and equipment.

As used herein, the term “container” means a vessel capable of holding a liquid. Within the context of this disclosure exemplary containers include pots, vats, fermentors, carboys, jars, etc. These containers may be made of any material suitable for holding liquid, such as glass, metal, ceramic, plastic, or other polymeric materials.

As used herein, the term “water” means the liquid defined by the chemical formula H2O. As used herein the term water includes pure water and/or water containing up to 1% of minerals and other materials frequently found in natural water sources or municipal water, such as chlorine, chloride, calcium, etc.

As used herein, the term “sparging the water” means driving gas into water in order to displace the existing gas. For example sparging water may be accomplished by bubbling gas through the water, for example by submerging a hose, needle, or other cylindrical device into the water and pushing gas through that device. In one embodiment, sparging the water comprises submerging a hose beneath the surface of the water and attaching the other end of the hose to a pressurized cylinder of inert gas, then pushing inert gas through the hose by opening a pressure regulator on the cylinder of inert gas.

As used herein, the term “inert gas” means gas that does not chemically react with the other reagents present in a particular chemical reaction. Within the context of this disclosure the term “inert gas” means a gas that does not react with the ingredients used to prepare a particular food or beverage. Examples of an “inert gas” include (but are not limited to) nitrogen, helium, argon, carbon dioxide, neon, xenon. Within the context of an inert gas, “react with the ingredients” means a chemical reaction leading to making or breaking a covalent bond in at least one molecule present in at least on ingredient.

As used herein, the term “comestible material” means a material that may be ingested by a human being. In one embodiment, a “comestible material” includes a material recognized as a “food” or “dietary supplement” by the Food and Drug Administration of the United States of America. In one embodiment, the term “comestible material” includes a material recognized as a “drug” or by the Food and Drug Administration of the United States of America.

As used herein, the term “heating” means increasing the kinetic energy. Heating may be accomplished by any means known in the cooking or chemical arts, such as direct flame, heating mantel, oil bath, steam bath, double boiler, microwave, solar, etc. One may measure the degree of heating with a thermometer of any variety.

In one embodiment, the disclosed method comprises heating the water to greater than 80° C.

In one embodiment, the disclosed method comprises heating the water to greater than 90° C.

In one embodiment, the disclosed method comprises heating the water to greater than 95° C.

In one embodiment, the disclosed method comprises heating the water to a boil at approximately 1 atmosphere of pressure.

In one embodiment, the disclosed method comprises heating the water to greater than 100° C. Heating the water to greater than 100° C. may be accomplished by using any means known in the cooking or chemical arts, such as direct flame, heating mantel, oil bath, steam bath, double boiler, microwave, solar, etc., under a pressure of greater than one atmosphere.

In one embodiment, the disclosed method comprises sparging the water with an inert gas chosen from Nitrogen, Carbon Dioxide, Argon, Helium, Neon, and Xenon.

In one embodiment, the disclosed method comprises filling the container with an inert gas chosen from Nitrogen, Carbon Dioxide, Argon, Helium, Neon, and Xenon. Filling the container with an inert gas may be accomplished by any method known in the chemical arts. In one example filling the container may be accomplished by purging the vessel with an inert gas for a period of time sufficient to replace the gas in the container with an inert gas. In another example, the container may be evacuated by applying a vacuum to the vessel before backfilling the vessel with an inert gas.

In one embodiment of the disclosed method, the comestible material comprises at least one terpene.

In one embodiment of the disclosed method, the water is filtered water. Within the context of this disclosure, “filtered water” means water that is directed through a means for removing non-water components from the water. A variety of filters are known in the art, including carbon filters, reverse osmosis filters, size-elusion filters, etc.

In one embodiment of the disclosed method, the comestible material comprises a sugar. Within the context of this disclosure the term sugar means and mono-, di-, tri-, or polysaccharide.

In one embodiment of the disclosed method, the sugar is maltose.

In one embodiment, the disclosed method comprises cooling the water. Within the context of this disclosure, the term “cooling” means lessing the kinetic energy. Cooling may be monitored or measured by using a thermometer to determine the temperature of the water.

In one embodiment, the disclosed method comprises cooling the water to less than 80° C.

In one embodiment, the disclosed method comprises cooling the water to less than 70° C.

In one embodiment, the disclosed method comprises cooling the water to less than 60° C.

In one embodiment, the disclosed method comprises cooling the water to less than 50° C.

In one embodiment, the disclosed method comprises cooling the water to less than 40° C.

In one embodiment, the disclosed method comprises cooling the water to less than 30° C.

In one embodiment, the disclosed method comprises cooling the water to a temperature suitable for yeast. As used herein, the term “suitable for yeast” means not killing, shocking, or otherwise harming the yeast or preventing it from conducting fermentation.

In one embodiment, the disclosed method comprises heating water comprising sugar to a temperature greater than 80° C. under an atmosphere having a concentration of between 15 to 20% oxygen. In one embodiment, the atmosphere has an oxygen concentration of between 10 to 15% oxygen. In one embodiment, the atmosphere has an oxygen concentration of between 8 to 10% oxygen. In one embodiment, the atmosphere has an oxygen concentration between 6 to 8% oxygen. In one embodiment, the atmosphere has an oxygen concentration of between 4 to 6% oxygen. In one embodiment, the atmosphere has an oxygen concentration of between 2 to 4% oxygen. In one embodiment, the atmosphere has an oxygen concentration of between 1 to 2% oxygen. In one embodiment, the atmosphere has an oxygen concentration of between 0.1 to 1% oxygen. In one embodiment, the atmosphere has an oxygen concentration of between 0.01 to 0.1%. In one embodiment, the atmosphere has an oxygen concentration of less than 0.01% oxygen.

In one embodiment, the disclosed method comprises heating water comprising sugar to a temperature greater than 90° C. under an atmosphere having a concentration of between 15 to 20% oxygen. In one embodiment, the atmosphere has an oxygen concentration of between 10 to 15% oxygen. In one embodiment, the atmosphere has an oxygen concentration of between 8 to 10% oxygen. In one embodiment, the atmosphere has an oxygen concentration between 6 to 8% oxygen. In one embodiment, the atmosphere has an oxygen concentration of between 4 to 6% oxygen. In one embodiment, the atmosphere has an oxygen concentration of between 2 to 4% oxygen. In one embodiment, the atmosphere has an oxygen concentration of between 1 to 2% oxygen. In one embodiment, the atmosphere has an oxygen concentration of between 0.1 to 1% oxygen. In one embodiment, the atmosphere has an oxygen concentration of between 0.01 to 0.1%. In one embodiment, the atmosphere has an oxygen concentration of less than 0.01% oxygen.

In one embodiment, the disclosed method comprises heating water comprising sugar to a temperature greater than 90° C. under an atmosphere having a concentration of less than 15% oxygen.

In one embodiment, the disclosed method comprises heating water comprising sugar to a temperature greater than 95° C. under an atmosphere having a concentration of less than 15% oxygen.

In one embodiment, the disclosed method comprises heating water comprising sugar to a temperature that boils the water (e.g., about 100 degrees Celsius) under an atmosphere having a concentration of between 15 to 20% oxygen. In one embodiment, the atmosphere has an oxygen concentration of between 10 to 15% oxygen. In one embodiment, the atmosphere has an oxygen concentration of between 8 to 10% oxygen. In one embodiment, the atmosphere has an oxygen concentration between 6 to 8% oxygen. In one embodiment, the atmosphere has an oxygen concentration of between 4 to 6% oxygen. In one embodiment, the atmosphere has an oxygen concentration of between 2 to 4% oxygen. In one embodiment, the atmosphere has an oxygen concentration of between 1 to 2% oxygen. In one embodiment, the atmosphere has an oxygen concentration of between 0.1 to 1% oxygen. In one embodiment, the atmosphere has an oxygen concentration of between 0.01 to 0.1%. In one embodiment, the atmosphere has an oxygen concentration of less than 0.01% oxygen. In one embodiment, the disclosed method comprises heating water comprising sugar to a temperature greater than 80° C. under an atmosphere having a concentration of less than 5% oxygen.

In one embodiment of the disclosed method, the atmosphere consists essentially of an inert gas.

In one embodiment of the disclosed method, the comestible is chosen from a fruit, a vegetable, an herb, a spice, coffee, or a flavonoid.

Disclosed herein is a product produced by:

adding water to a container;

sparging the water with inert gas;

filling the container with inert gas;

adding a comestible to the water; and

heating the water.

In one embodiment, of the disclosed product by process, the comestible is chosen from grain extract, hops, a fruit, a vegetable, an herb, a spice, coffee, or a flavonoid.

As used herein, the term flavonoid includes any molecule imparting flavor on the composition to which it is added. Within the context of this disclosure a flavonoid may be naturally occurring (e.g., an compound found in hops) or not naturally occurring (e.g., a synthetic favor compound).

In one embodiment the product by process comprises heating the water to 90 to 110° C. under an atmosphere consisting essentially of inert gas.

Disclosed herein is a method of making beer comprising:

adding water to a container;

sparging the water with inert gas;

filling the container with inert gas;

adding a flavonoid to the water; and

heating the water.

In one embodiment, the disclosed method of making beer comprises adding a sugar to the container.

In one embodiment, the disclosed method of making beer comprises cooling the water.

In one embodiment, the disclosed method of making beer comprises adding yeast to the water after cooling the water. Within the context of this disclosure “yeast” means a microscopic fungus consisting of single oval cells that reproduce by budding, and are capable of converting sugar into alcohol and carbon dioxide. A variety of yeasts are known and commercially available.

In one embodiment, the disclosed method of making beer comprises first heating grain extract in water under an inert atmosphere, then cooling the water, then adding yeast to the water.

In one embodiment, the disclosed method of making beer comprises adding oxygen to the water after heating the water under an inert atmosphere.

In one embodiment, the disclosed method of making beer comprises fermenting the mixture of grain extract and yeast under an inert atmosphere after heating the said grain extract under an inert atmosphere.

In one embodiment, the disclosed method of making beer comprises water having at least one terpene during the heating of the water.

In one embodiment, the disclosed method of making beer comprises heating a mixture of grain extract and hops in water under an inert atmosphere.

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

### NON-LIMITING EXAMPLE

The following example is intended to show one way to perform one exemplary embodiment of the above disclosed invention. It should be appreciated this example could be modified in a variety of ways while still maintaining the novelty and non-obviousness of the above-disclosed invention.
1. A cheesecloth grain sack charged with Golden Promise Grain (6 oz) was added to 5 Gallons of nitrogen-sparged water at 160 degrees F.
2. With continuous stirring and nitrogen sparging, Pilsen extract (7 lbs, light dry malt extract, Lovibond 2) was added to the light amber solution. The resulting suspension was stirred until all of the Pilsen extract dissolved, resulting in an amber solution.
3. After 30 minutes, the grain sack was removed, leaving 5 Gallons of light amber solution.
4. The 5 Gallons of light amber solution was transferred via cannula to a pre-heated, nitrogen-sparged 6 Gallon vessel equipped with a bubbler.
5. The vessel charged with 5 Gallons of light amber solution was placed in a 212 degree F. water bath.
6. The vessel was heated in the 212 F bath under continuous nitrogen sparging and intermittent swirling for 70 minutes.
7. Hops (as a mixture of ½ oz of Warner, ½ oz of Simcoe, and 0.8 oz of Amarillo) were added to the solution at 10 minute increments under heavy nitrogen purge.
8. After 70 minutes in the hot water bath, hops (½ oz Amarillo) were added to the reaction mixture and the vessel was removed from the hot water bath.
9. The reaction mixture was cooled to 68 F over two hours.
10. Yeast (1 package of Wyeast 1187 Ringwood Ale) was added to the reaction mixture.
11. One Gallon of the reaction mixture was cannula transferred into a nitrogen-sparged vessel and capped with an airlock.
12. The vessel containing the remaining 4 Gallons of the reaction mixture was opened to the ambient atmosphere while swirling the reactions mixture.
13. The original gravity was measured (1.060 at 70 degrees F.) using a hydrometer.
14. Each of the 1 Gallon and 4 Gallon batches were allowed to stand at 70 degrees F.
15. Fermentation was apparent after 30 hours.
16. Fermentation was allowed to precede for 7 days, after which time the reaction mixture was transferred to a secondary fermentor, where it was allowed to rest for 13 days.
17. After 13 days, the reaction mixture was transferred to a 5 Gallon Cornelius keg and carbonated by applying 25 psi of carbon dioxide thereto.

1. A method of making a beverage comprising:
adding water to a container;
sparging the water with inert gas;
filling the container with inert gas;
adding comestible material to the water; and
heating the water.

2. The method of claim 1, comprising heating the water to greater than 80° C.

3. The method of claim 1, comprising heating the water to greater than 90° C.

4. The method of claim 1, comprising heating the water to greater than 95° C.

5. The method of claim 1, comprising heating the water to a boil at approximately 1 atmosphere of pressure.

6. The method of claim 1, comprising sparging the water with an inert gas chosen from Nitrogen, Carbon Dioxide, Argon, Helium, Neon, and Xenon.

7. The method of claim 1, comprising filling the container with an inert gas chosen from Nitrogen, Carbon Dioxide, Argon, Helium, Neon, and Xenon.

8. The method of claim 1, wherein the comestible material comprises at least one terpene.

9. The method of claim 1, wherein the water is filtered water.

10. The method of claim 1, wherein the comestible material comprises a sugar.

11. The method of claim 10, wherein the sugar is maltose.

12. The method of claim 1, comprising cooling the water.

13. The method of claim 12, comprising cooling the water to less than 80° C.

14. The method of claim 1, comprising heating water comprising sugar to a temperature greater than 80° C. under an atmosphere having a concentration of less than 15% oxygen.

15. The method of claim 14, comprising heating water comprising sugar to a temperature greater than 80° C. under an atmosphere having a concentration of less than 5% oxygen.

16. The method of claim 15, wherein the atmosphere consists essentially of an inert gas.

17. The method of claim 1, wherein the comestible is chosen from a fruit, a vegetable, an herb, a spice, coffee, or a flavonoid.

18. A product produced by:
adding water to a container;
sparging the water with inert gas;
filling the container with inert gas;
adding a comestible to the water; and
heating the water.

19. The product produced by claim 18, wherein the comestible is chosen from grain extract, hops, a fruit, a vegetable, an herb, a spice, coffee, or a flavonoid.

20. The product for claim 18, comprising heating the water to 90 to 110° C. under an atmosphere consisting essentially of inert gas.

21.-29. (canceled)
